(19) United States
(12) Patent Application Publication
(10) Pub. No.: US 2024/0283389 A1
(43) Pub. Date: Aug. 22, 2024

(54) A POWER SUPPLY ARRANGEMENT

(71) Applicant: Green Energy AS, Oslo (NO)

(72) Inventor: Karl ANDREASSEN, Vejle (DK)

(73) Assignee: Green Energy AS, Oslo (NO)

(21) Appl. No.: 18/570,360

(22) PCT Filed: Jun. 10, 2022
(86) PCT No.: PCT/EP2022/065821

§ 371 Date: Dec. 14, 2023

(30) Foreign Application Priority Data
Jun. 17, 2021 (NO) 20210789

(51) Int. Cl. H02S 20/30; B63B 25/00; B63J 3/04; H02S 30/20

(52) U.S. Cl. CPC H02S 20/30; B63B 25/004; B63J 3/04; H02S 30/20

(57) ABSTRACT

A renewable power supply arrangement for use on board a sea-going vessel. The arrangement comprises at least one flexible solar panel (50) capable of being folded or rolled-up when not in use. The solar panel (50) is primarily intended for placement on the outside of a stack of containers (30) on the deck of the vessel.

### TECHNICAL FIELD

The present invention relates to power supply on board a sea-going vessel, such as a transport ship. The invention is especially adapted to provide renewable energy to auxiliary systems on board the vessel, such as to cooling or freezing containers transported by the vessel.

### BACKGROUND ART

A seagoing vessel requires a substantial amount of energy. As a sea-going vessel can be connected to the electrical grid only when it is in port, this energy is generally provided by burning fossil fuels. It is estimated that the world's fleet of transport vessels account for about 2% of the total CO₂ emissions of the world (https://www.iea.org/reports/international-shipping). It is therefore a great need to reduce this consumption.

It is known that reducing the speed of a vessel will reduce the fuel consumption substantially. For example a reduction of the speed from 24 knots to 21 knots will reduce the fuel consumption by 33% (https://transportgeography.org/contents/chapter4/transportation-and-energy/fuel-consumption-containerships/).

However, a slower speed means that the transport will take longer time. A longer time results in a greater total consumption of energy for auxiliary systems onboard the ship, such as for cooling the goods that the vessel is transporting. As a substantial part of the goods transport across the world takes place in areas where the temperature can get very high, even at the middle of the sea, there is a great need for controlling the temperature of the goods. Today, most goods are transported in containers. Special containers have been developed for providing a temperature-controlled environment inside of the container. This can be temperatures below freezing or temperatures above freezing but below a certain upper limit. Ships for transporting such containers are often termed reefers. The goods that are transported in such temperature-controlled containers are typically food products but may also range from flower to batteries.

The electricity for running the cooling or freezing containers comes today practically exclusively from generators driven by hydrocarbon-fuelled engines, running on hydrocarbons.

Some attempts have been made to harvest solar energy onboard boats. However, these solutions are intended for small boats. One such example is known from CN112532154A and CN112636683A. The publications describe a small, unmanned twin-hull boat having a platform extending between the hulls. On the platform a dedicated curved structure is arranged. The structure is equipped with a flexible solar panel that can be raised along the structure to collect sun energy and spooled onto a roll when it is not needed.

CN112960078A and CN211568242U show a small sailboat having a flexible solar panel glued to the deck.

None of the above solutions are intended for larges ships, such as a container ship.

### SUMMARY OF INVENTION

The present invention has as an object to eliminate or at least reduce the need for operating such engines and make use of renewable energy in the form of solar power to supply the vessel with auxiliary energy.

By auxiliary energy is meant all types of energy on board the vessel that is not concerning propulsion. In addition to the supply of electricity to operate cooling and freezing containers, the auxiliary energy is used for lighting, heating, air conditioning, domestic appliances, control systems, elevators and other types of equipment and systems requiring electricity on board the vessel. It is the aim of the present invention to replace as much of this consumption as possible with solar energy.

Any surplus energy created by the present invention may of course be used for propulsion, such as when the vessel operates near a harbour, other populated areas or particularly vulnerable areas.

One or more of the above objectives are achieved by the features of the accompanying claims.

### BRIEF DESCRIPTION OF DRAWINGS

The invention will now be described, referring to the enclosed drawings, in which:

FIG. 1 shows a segment of a container ship having a power supply arrangement according to the invention, including flexible solar panels,

FIG. 2 shows a detailed view of FIG. 1,

FIG. 3 shows a side elevation view of the arrangement of FIG. 1,

FIG. 4 shows a cross-section through a column and rail arrangement for raising and lowering the flexible solar panels,

FIG. 5 shows an isometric cross-section of the upper part of the column and rail arrangement,

FIG. 6 shows a view from the top of the column and rail arrangement,

FIG. 7 shows a detail of a roller coupled to the flexible solar panel,

FIG. 8 shows a lower part of the column and rail in isometric view,

FIG. 9 shows a cross section elevation view of the lower part of the column and rail arrangement, and

FIG. 10 shows a view of the rail system from below.

### DETAILED DESCRIPTION OF THE INVENTION

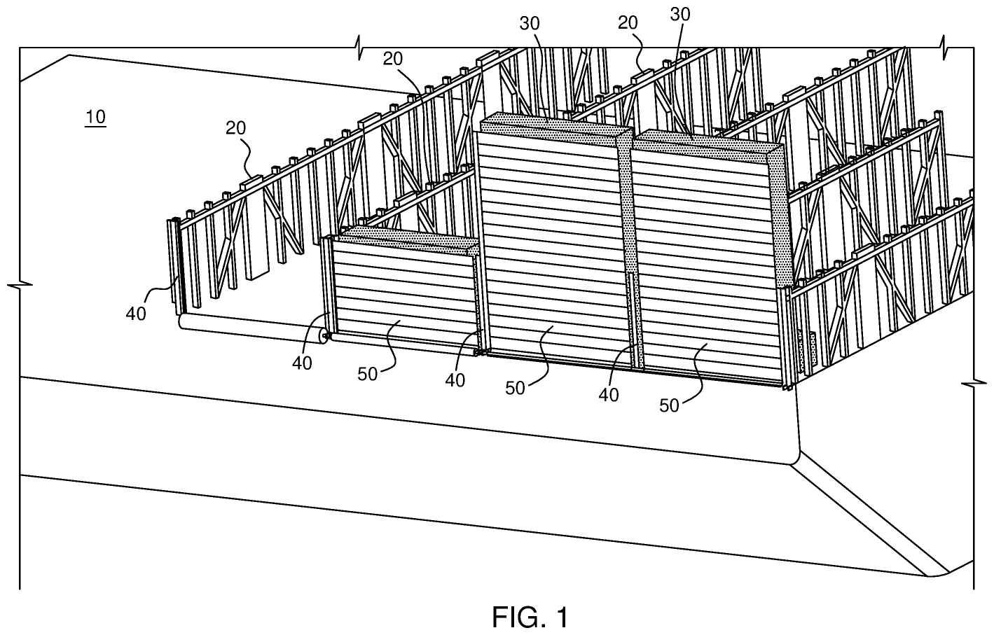

FIG. 1 shows a segment of a container ship having a deck 10. On the deck are fixedly attached a number of structures termed lashing bridges 20. Such lashing bridges 20 have over the later years become widely used on container ships in order to prevent stacks of containers from toppling.

In the figures are shown an outer stack of containers 3. It should, however, be understood that stacks of containers may fill the space between the latching bridges 20. Each container 30 is secured to the latching bridges by known means.

The stacking of containers 30 and their attachment to the latching bridges 20 are not a part of the present invention. It is also possible to use the present invention on container ships without latching bridges.

At the ends of the latching bridges 20 are arranged rail columns 40 to support and guide rollable or foldable solar panels 50. It is convenient to attach these rail columns 40 to the latching bridges 20. If the ship has no latching bridges, a support structure for the rail columns 40 may be attached to the deck 10, such as by welding.

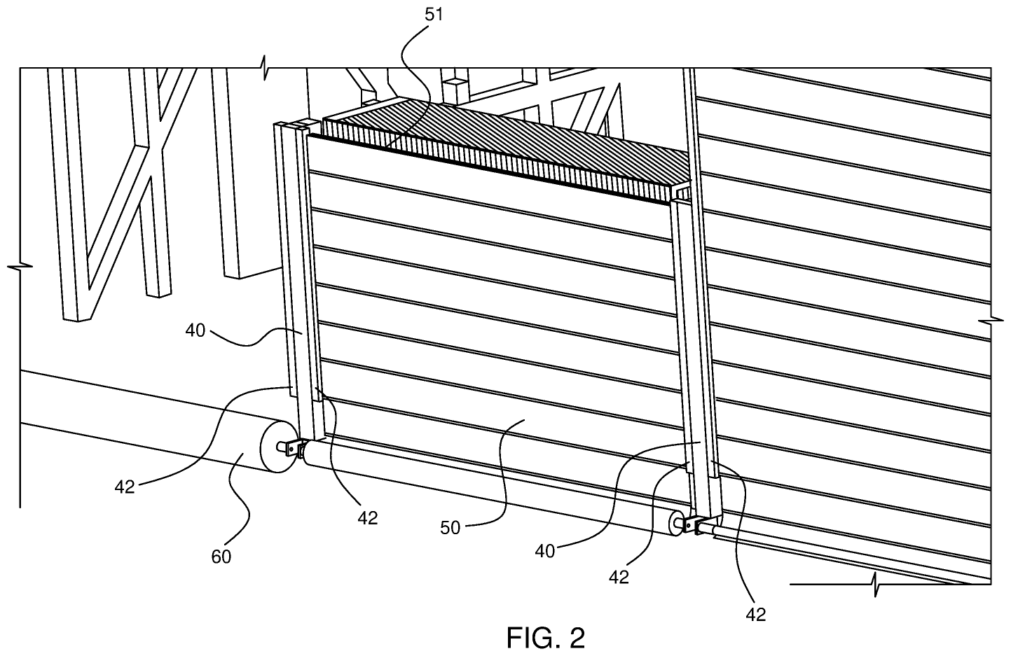

FIG. 2 shows a closer look at the rail columns 40 and solar panels 50. The solar panels 50 are flexible and can be rolled up on a cylindrical roll 60 that is arranged horizontally at the lower ends of the rail columns 40. The rolls 60 extends between two adjacent rail columns 40.

Each rail column 40 has two rails 42 attached thereto, one on each side of the rail column 40.

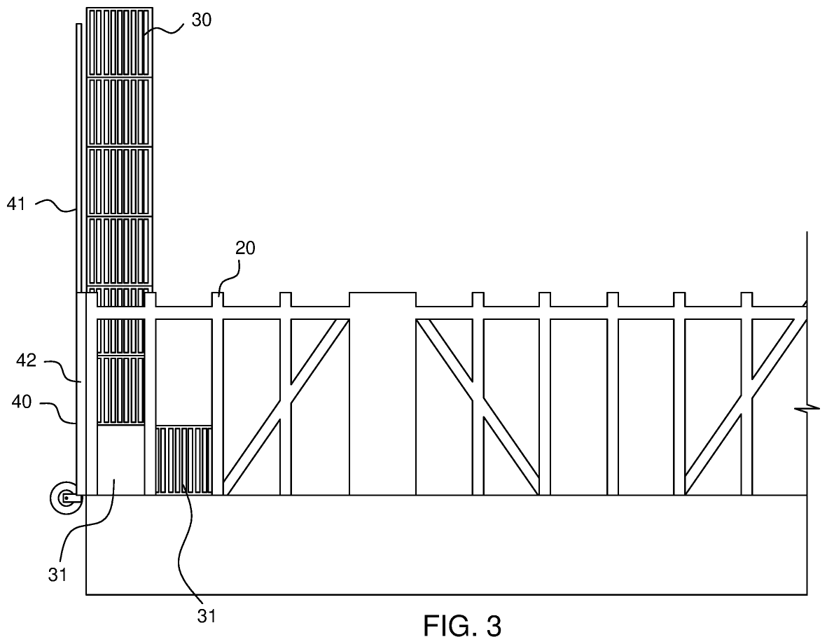

FIG. 3 shows a side elevation view of the arrangement of the invention. Here is shown a rail column 40 with a rail 42 attached to the end of a latching bridge 20. A telescopic extension rail 41 extends upward from the fixed rail 42. Inward of the rail column 40 and the rails 42, 41 is the first stack of containers 30. The lowest container space 31 may be vacant to allow for placing a charging module and electric accumulators, as well as power supply for the cooling and freezing containers. One container 32 is shown at the lowest position of the second stack. When the ship has been fully loaded, there will be stacks of containers in all available positions of the latching bridges 20.

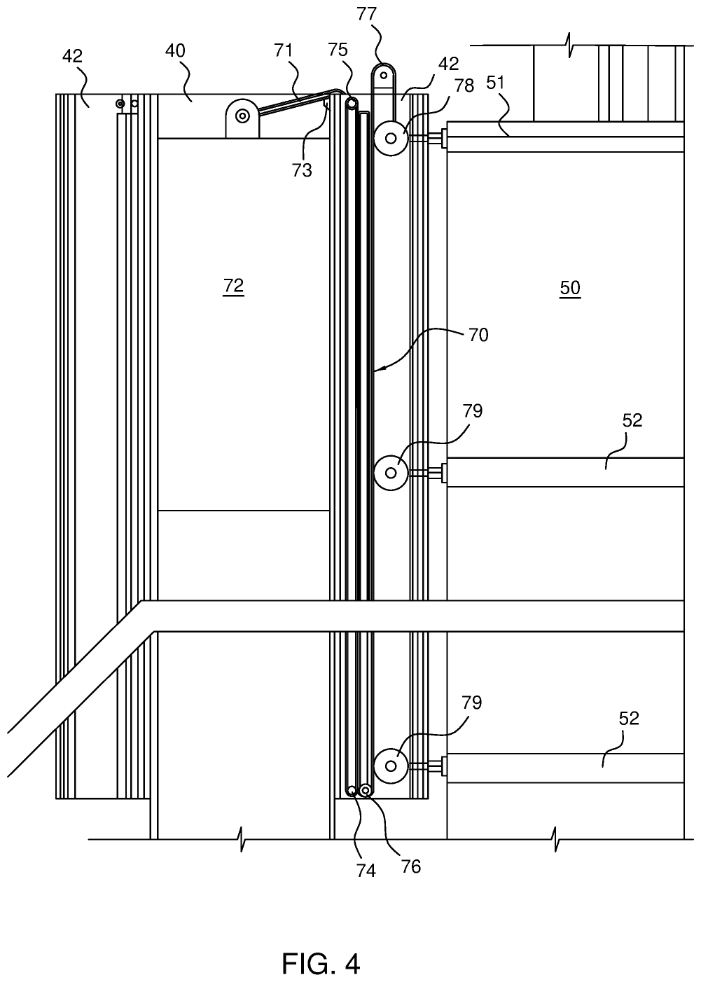

FIG. 4 shows a cross-section in a vertical direction through a rail column 40. This shows the rail 42 on each side of the column 40. In the right-hand column 42 is shown the wire and sheave mechanism 70 inside the rail 42. This comprises a wire 71 that at one end is attached to a counterweight 72 and extends over a first sheave 73 at the top of the fixed rail 42, down to a second sheave 74 at the lower end of a first telescoping rail 41a, upward to a third sheave 75 at the upper end of the first telescoping rail 41a, downward again to a fourth sheave 76 at the lower end of a second telescoping rail 41b and upward again to a fifth sheave coupled to the top of the second telescoping rail 41b, and finally to an upper roller 78.

The upper roller 78 is adapted to travel within the second telescoping rail 41b. It is attached to an upper bar 51 to which an upper edge of the flexible solar panel 50 is attached. The bar 51 extends between two rail columns 40, as shown in FIG. 2, to support the solar panel 50 at both sides.

Rollers 79 similar to the upper roller 79 and bars 52 are arranged at spaced apart locations along the flexible solar panel 50 and the second telescopic rail 41b to support the flexible solar panel 50.

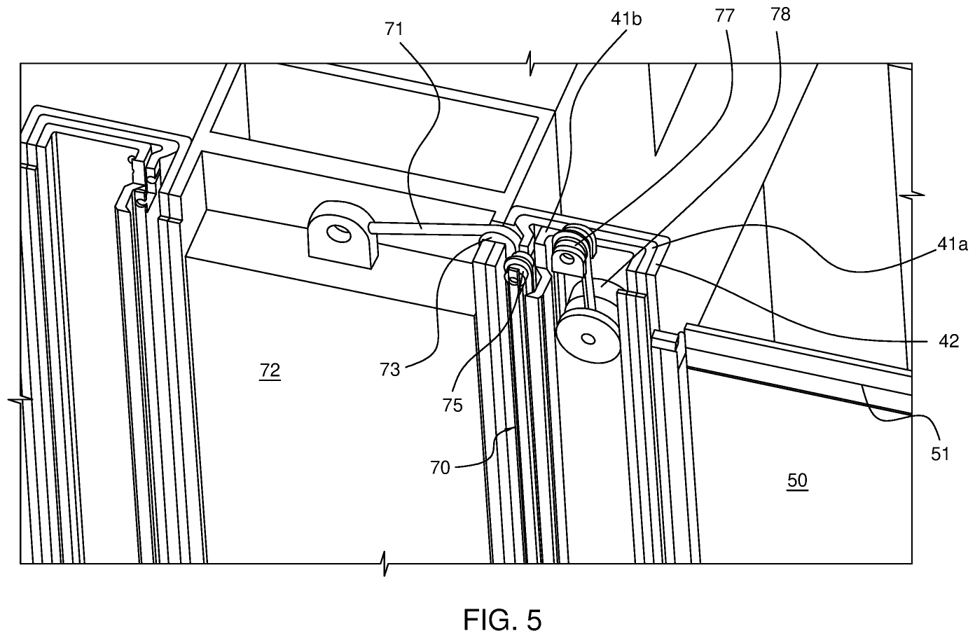

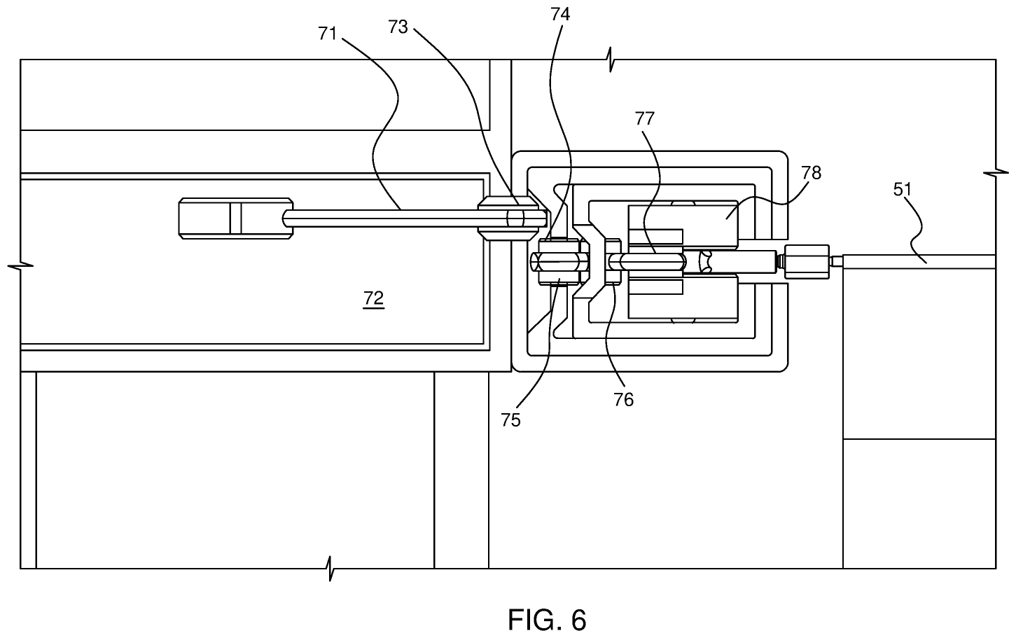

FIG. 5 shows a part of the wire and sheave mechanism 70 and rails 42, 41a, 41b in isometric view from the top, and FIG. 6 shows the same component in planar view from the top.

The flexible solar panel can be raised by turning a motor (not shown) arranged within the roll 60 to roll out the flexible solar panel. The counterweight 72 will then be allowed to move downwards within the column 40 and pull the wire 71 along.

The roll 60 may be driven by an electric motor that is housed within the roll 60 in a per se known manner.

When the flexible solar panel 50 is to be lowered and rolled up, the roll motor is reversed and rolls up the solar panel 50. The counterweight 72 is then lifted again to the top of the column 40.

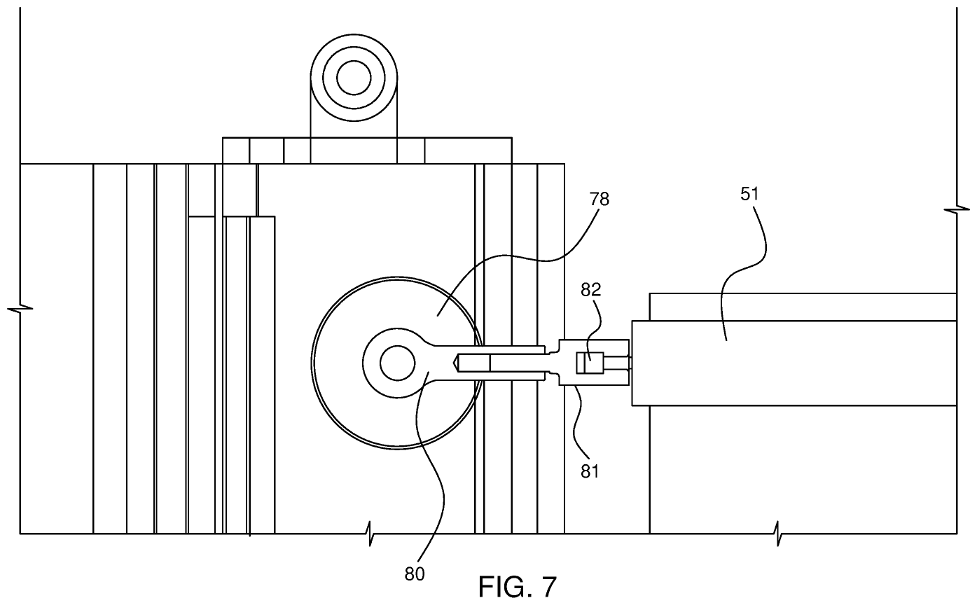

FIG. 7 shows the connection between the bar 51 and the roller 78. An arm 80 is journaled about the centre of the roller 78. A threaded pin 81 is screwed into a blind hole at the outer end of the arm 80 and a dovetailed peg 82 is received in the opposite end of the pin 81 from the threads. This provides some freedom of movement of the bar 51 relative to the roller 78. The remaining rollers 79 and bars 52 may be interconnected in a similar way.

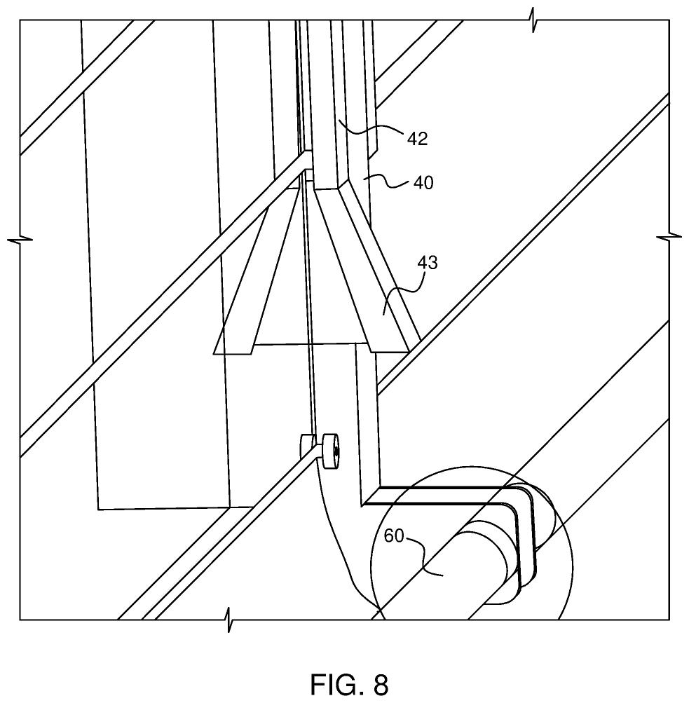

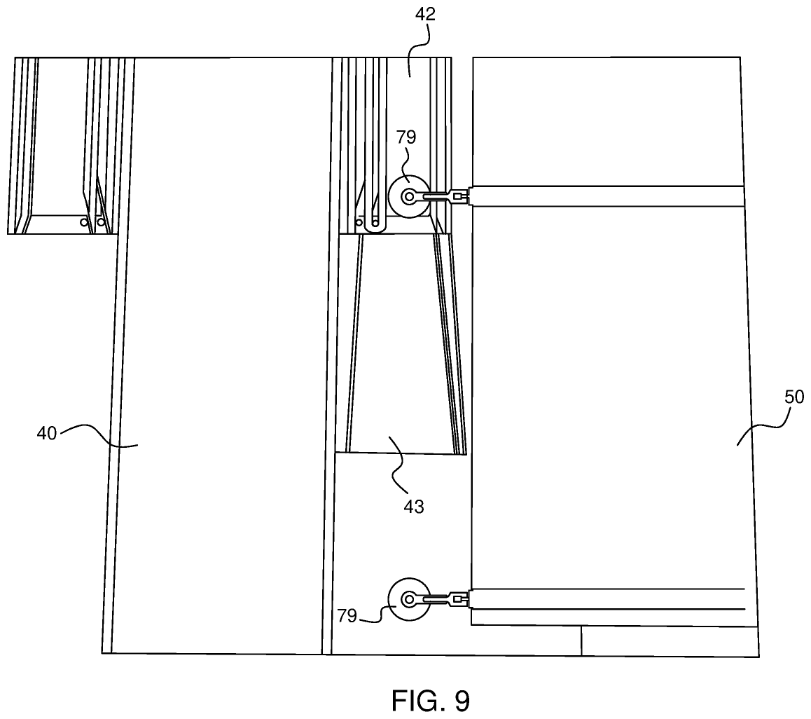

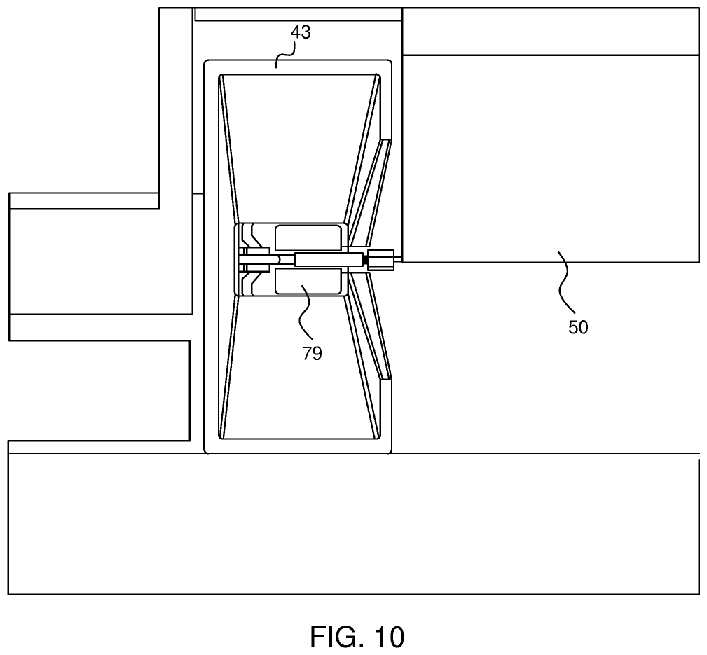

FIGS. 8-10 show the lower part of the column 40 and the rail 42 has a flared portion 43, i.e. a portion of the rail is substantially wider at the bottom. This is to facilitate the receival of the rollers 79 into the rail 42. As can be seen in FIG. 9, the flared portion 43 is also somewhat widened in the direction of the plane of the solar panels 50.

The roll 60 may be driven by an electric motor that is housed within the roll 60 and is hence protected from sea spray. To roll up the solar panel 50, the motor is turned and pulls the solar panel 50 onto the roll 60. The rollers 79 that are attached to the bars 52 are one by one pulled out from the lower flared end 43 of the rail 42. When the solar panel 50 is raised again, the rollers 79 again enter the inside of the rail 42 through the flared portion 43. As will be understood, the flared portion will receive the rollers 79 even if they become somewhat skewed from the longitudinal axis of the rail 42.

As an alternative to rolling up the panels 50, they can be folded, such as into an open top container arranged below the panel 50

The solar panels of the present invention are primarily intended to be raised when there is a stack of containers arranged inward of the solar panel. The stack of containers will protect the solar panels from the impact and load of wind. When the ship has no deck load the solar panels may still be used if the wind speed is sufficiently low. It is convenient to provide a wind meter that is coupled to a control system that lowers the solar panels if the wind speed is too high for safe use, or if the wind comes from an inconvenient direction.

Sometimes it may be safe to use the solar panels on one side of the ship and not on the other. The control system may be set up with wind meters arranged at one or more places on the ship, so that individual solar panels may be raised or lowered depending on local wind variations.

At sea, the sunlight will be reflected from the sea and hit the solar panels. Consequently, the panels will be very effective, even at the shady side of the ship. It is, however, convenient to lower some of the solar panels when the need for power is lower than the total capacity of the solar panels. Excess power may be stored in battery modules on board the ship for use when there is too little sunlight or when the solar panels have to be lowered for protection.

The solar panels are themselves made of materials that are durable and can withstand both intensive sunlight and salt water. Rails, rollers, wire and other parts are conveniently made of durable plastic or stainless steel.

It may be advantageous to rinse the solar panels from time to time to remove residuals therefrom. This can be done while the ship is at port.

1-12. (canceled)

13. A container ship comprising a deck space assigned for carrying containers, the container ship having a renewable power supply arrangement, the power supply arrangement comprising at least one flexible foldable or rollable solar panel, wherein the flexible solar panel is arranged laterally outside of the deck space.

14. The container ship of claim 13, wherein the flexible solar panel is coupled to at least one rail, the rail being attached to a latching bridge on a vessel.

15. The container ship of claim 14, wherein the flexible solar panel is coupled to one rail on each lateral side thereof.

16. The container ship of claim 14, wherein the rail comprises a fixed rail that is attached to the latching bridge and at least one telescoping rail received within the fixed rail.

17. The container ship of claim 14, wherein the flexible solar panel is coupled to the rail via at least one roller that is adapted to travel along the rail.

18. The container ship of claim 14, wherein the flexible solar panel is coupled to a wire and sheave mechanism, adapted to pull the flexible solar panel upwards.

19. The container ship of claim 18, wherein the wire and sheave mechanism comprises a counterweight.

20. The container ship of claim 13, wherein the roller is a rotatably driven roll adapted to spool the flexible solar panel on an outside thereof.

21. The container ship of claim 13, wherein the power supply arrangement comprises a plurality of flexible solar panels along the gunwale of the ship, each the solar panel being individually raisable and lowerable.

22. The container ship of claim 14, wherein the flexible solar panel is coupled to the rail via rollers that are capable of travelling along the rails.

23. The container ship of claim 22, wherein the rail has a flared lower portion.

24. The container ship of claim 23, wherein the rollers are pulled out of the rail through the flared portion when the flexible solar panel is rolled or folded.
